(19) United States
(12) Patent Application Publication
(10) Pub. No.: US 2025/0213977 A1
(43) Pub. Date: Jul. 3, 2025

(54) METHOD AND DEVICE FOR CONTROLING MOTION OF VIRTUAL CHARACTER, AND STORAGE MEDIUM

(71) Applicant: BIGO TECHNOLOGY PTE. LTD., Mapletree Business City (SG)

(72) Inventor: Jianjun CHEN, Guangzhou (CN)

(21) Appl. No.: 18/848,740

(22) PCT Filed: Mar. 27, 2023
(86) PCT No.: PCT/CN2023/083969

§ 371 Date: Sep. 19, 2024

(30) Foreign Application Priority Data
Mar. 28, 2022 (CN) 202210313961.2

(51) Int. Cl. A63F 13/56; A63F 13/577

(52) U.S. Cl. CPC A63F 13/56; A63F 13/577

(57) ABSTRACT

Provided is a method for controlling a motion of a virtual character. The method includes: acquiring original motion data; determining initial motion data of the virtual character; constructing a target function using the initial motion data and the original motion data; generating a collision constraint between the plurality of skeletal joint points of the virtual character and a profile joint point of the virtual character, and generating a length constraint between adjacent skeletal joint points in the plurality of skeletal joint points of the virtual character; acquiring target position data of the virtual character by solving a minimum distance value of the target function under the length constraint and the collision constraint; and driving the virtual character to perform the target motion by controlling the plurality of skeletal joint points of the virtual character to move to positions indicated by the target position data.

The application claims priority to Chinese Patent Application No. 202210313961.2, filed with China National Intellectual Property Administration on Mar. 28, 2022, the disclosure of which is herein incorporated by reference in its entirety.

### TECHNICAL FIELD

The present disclosure relates to the field of virtual interaction technologies, and in particular, to a method, apparatus, and device for controlling a motion of a virtual character, and a storage medium.

### BACKGROUND

With the emergence of virtual characters such as virtual anchors, virtual idols, and virtual employees, more and more applications in which the motions of the virtual characters are controlled based on captured motion data appear, and there is an increasing demand for real-time reusing the captured motion data to a variety of virtual characters with different profiles (fat or thin, tall or short, long or short limbs, large head, puffy skirt, etc.)

There are mainly two methods applicable to controlling the motion of the virtual character. One of the methods includes acquiring a translation amount by scaling, at an equal proportion, a skeleton of an original model to be a skeleton of the virtual character, then modifying the motion data based on the translation amount, and applying the motion data upon translation modifying to the virtual character. The other method includes applying rotation data of bones of the original model to the virtual characters with different proportion shapes or sizes directly by forward kinematics.

The above method for controlling the virtual character by scaling at an equal proportion does not take into account a profile of the virtual character, leading to the loss or aliasing of motion semantics or even the phenomenon of clipping. The method for controlling the virtual character using forward kinematics leads to the loss or aliasing of semantics as shown in FIG. 1. In FIG. 1, the left is a schematic diagram of the original model making a salute, and the middle is the motion made by the virtual character upon being controlled by forward kinematics. It can be seen that the salute motion made by the virtual character in the middle schematic diagram and the expected salute motion made by the virtual character in the right schematic diagram have defects of losing information or losing shape.

### SUMMARY

Embodiments of the present disclosure provide a method, apparatus, and device for controlling a motion of a virtual character, and a storage medium, which solve the problems of loss and aliasing of motion semantics and clipping in motion control of the virtual character in the related art.

The embodiments of the present disclosure provide a method for controlling a motion of a virtual character. The method includes: acquiring original motion data, wherein the original motion data is position data of a plurality of skeletal joint points of an original model in a case that the original model performs a target motion; determining initial motion data of the virtual character based on the original motion data, wherein the initial motion data is initial position data of a plurality of skeletal joint points of the virtual character; constructing a target function using the initial motion data and the original motion data, wherein the target function is configured for calculating a similarity between the initial motion data and the original motion data; generating a collision constraint between the plurality of skeletal joint points of the virtual character and a profile joint point of the virtual character, and generating a length constraint between adjacent skeletal joint points in the plurality of skeletal joint points of the virtual character with an unchanged distance between the adjacent skeletal joint points; acquiring target motion data of the virtual character by solving a minimum distance value of the target function under the length constraint and the collision constraint, wherein the target motion data is target position data of the plurality of skeletal joint points of the virtual character; and driving the virtual character to perform the target motion by controlling the plurality of skeletal joint points of the virtual character to move to positions indicated by the target position data.

The embodiments of the present disclosure provide an apparatus for controlling a motion of a virtual character. The apparatus includes: an original motion data acquiring module, configured to acquire original motion data, wherein the original motion data is position data of a plurality of skeletal joint points of an original model in a case that the original model performs a target motion; an initial motion data determining module, configured to determine initial motion data of the virtual character based on the original motion data, wherein the initial motion data is initial position data of a plurality of skeletal joint points of the virtual character; a target function generating module, configured to construct a target function using the initial motion data and the original motion data, wherein the target function is configured for calculating a similarity between the initial motion data and the original motion data; a constraint constructing module, configured to generate a collision constraint between the plurality of skeletal joint points of the virtual character and a profile joint point of the virtual character, and generate a length constraint between adjacent skeletal joint points in the plurality of skeletal joint points of the virtual character with an unchanged distance between the adjacent skeletal joint points; a target function solving module, configured to acquire target motion data of the virtual character by solving a minimum distance value of the target function under the length constraint and the collision constraint, wherein the target motion data is target position data of the plurality of skeletal joint points of the virtual character; and a virtual character controlling module, configured to drive the virtual character to perform the target motion by controlling the plurality of skeletal joint points of the virtual character to move to positions indicated by the target position data.

The embodiments of the present disclosure provide a device for controlling a motion of a virtual character. The device for controlling the motion of the virtual character includes: at least one processor; and a storage apparatus, configured to store at least one computer program, wherein the at least one computer program, when executed by the at least one processor, causes the at least one processor to perform the method for controlling the motion of the virtual character according to the present disclosure.

The embodiments of the present disclosure provide a computer-readable storage medium storing a computer program, wherein the computer program, when executed by a processor, causes the processor to perform the method for controlling the motion of the virtual character according to the present disclosure.

The embodiments of the present disclosure provide a computer program product including one or more instructions, wherein the one or more instructions, when loaded and executed by a processor, cause the processor to perform the method for controlling the motion of the virtual character.

### BRIEF DESCRIPTION OF DRAWINGS

FIG. 1 is a schematic diagram of motion semantics aliasing in motion control of a virtual character in the related art;

FIG. 2 is a flowchart of a method for controlling a motion of a virtual character according to Embodiment 1 of the present disclosure;

FIG. 3A is a flowchart of a method for controlling a motion of a virtual character according to Embodiment 2 of the present disclosure;

FIG. 3B is a schematic diagram of adding a profile joint point according to some illustrative embodiments of the present disclosure;

FIG. 3C is a schematic diagram of skeletal joint points according to some embodiments of the present disclosure;

FIG. 3D is a schematic diagram of a diagrammatic joint point adjacency matrix according to some embodiments of the present disclosure;

FIG. 3E is a schematic diagram of a motion adjacency relationship according to some embodiments of the present disclosure;

FIG. 3F is a schematic diagram of a collision constraint according to some embodiments of the present disclosure;

FIG. 4 is a structural block diagram of an apparatus for controlling a motion of a virtual character according to Embodiment 3 of the present disclosure; and

FIG. 5 is a structural block diagram of a device for controlling a motion of a virtual character according to Embodiment 4 of the present disclosure.

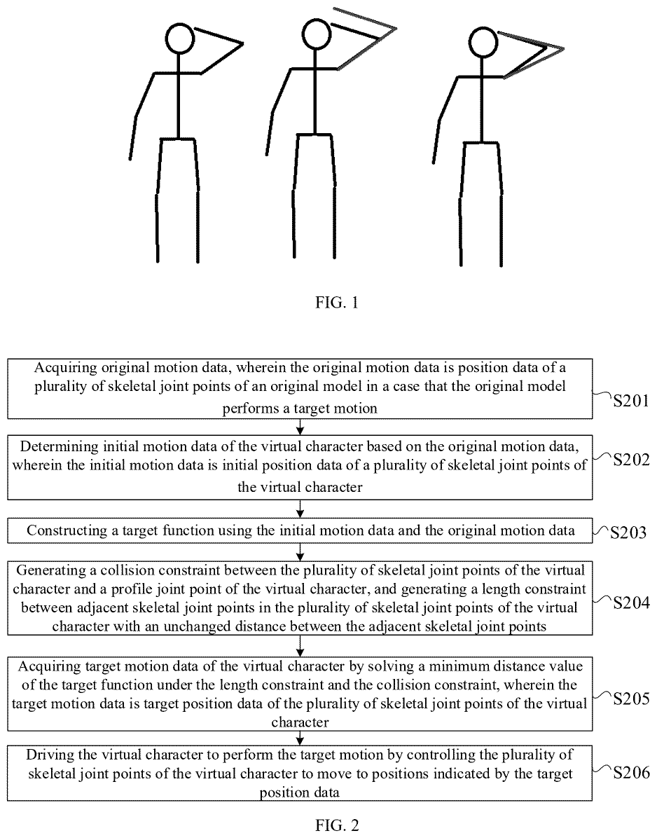

### DETAILED DESCRIPTION

The present disclosure is described hereinafter in combination with the accompanying drawings and embodiments below. It can be understood that the embodiments described herein are only to illustrate the present disclosure, but do not tend to limit the present disclosure. In addition, it should also be noted that for the convenience of descriptions, only some structures related to the present disclosure are shown in the drawings.

### Embodiment 1

FIG. 2 is a flowchart of a method for controlling a motion of a virtual character according to Embodiment 1 of the present disclosure. The embodiment of the present disclosure is applicable to the case of controlling the virtual character to simulate a motion by capturing a motion of an original model. In some embodiments, the method is executed by an apparatus for controlling a motion of a virtual character according to some embodiments of the present disclosure, and the apparatus for controlling the motion of the virtual character is implemented by hardware or software and integrated into the motion control of the virtual character according to the embodiments of the present disclosure. As shown in FIG. 2, the method for controlling the motion of the virtual character according to the embodiments of the present disclosure includes the following processes.

In S201: original motion data is acquired, wherein the original motion data is position data of a plurality of skeletal joint points of the original model in the case that the original model performs a target motion.

In some embodiments of the present disclosure, the original model is a model making the target motion, and the virtual character is a character simulating the target motion made by the original model. In some embodiments, the original model is a human body model and the virtual character is a digital person. In some embodiments, the original model is a real human body in real life, and the virtual character is a virtual anchor, a virtual host, a virtual doll, a robot, etc. In some embodiments, the original model is an animal and the virtual character is a virtual animal. The original model and the virtual character have the same skeleton structures. For the convenience of explanation, the embodiments of the present disclosure take the original model as a person in real life and the virtual character as a virtual person as an example to explain the method for controlling the motion of the virtual character.

In an application scenario, in the case that the virtual doll in a network is controlled by capturing the motion of the anchor, the anchor is the original model, the virtual doll is the virtual character, and the virtual doll needs to make the same motion as the anchor. In some embodiments, for acquiring the original motion data, at least one image of the anchor is captured through a camera, and the position data of the plurality of skeletal joint points in the case that the anchor makes the target motion is acquired as the original motion data by performing joint point identification on the at least one image. In some embodiments, the at least one image is input into a pre-trained human body joint point recognition network to acquire the position data of the plurality of skeletal joint points of the anchor as the original motion data.

In S202: initial motion data of the virtual character is determined based on the original motion data, wherein the initial motion data is initial position data of a plurality of skeletal joint points of the virtual character.

In some embodiments, the motion data is rotation data of a bone in the model, and the original model performing the target motion is regarded as the moving of a skeleton of the original model. The skeleton is formed by a plurality of connected bones and the plurality of bones have a father-son connection relationship, and the rotation motion of a child bone relative to a father bone is recorded by a matrix in some embodiments. In the human skeleton, the root bone is a pelvis, the child bone connected to the pelvis upwards and child bones of the child bone have a transmission relationship, such as, from the pelvis upwards through the spine, the big arm and the forearm, and then to the hand, and motion data of the hand is acquired by sequentially multiplying rotation matrices of all the bones from the pelvis to the hand. Because the skeletal joint points are nodes connecting the bones, the position data of the plurality of skeletal joint points can be determined upon the rotation data of the bones being acquired, or the rotation data of the bones defined by the plurality of skeletal joint points can be acquired upon the position data of the plurality of skeletal joint points being acquired.

In the embodiments of the present disclosure, the original motion data represents the target motion made by the original model, and the original motion data is assigned to the bones of the virtual character, that is, a plurality of bones of the virtual character are initialized, so that the plurality of bones of the virtual character have the same rotation data as the corresponding bones in the original model, that is, the position data of the plurality of skeletal joint points in the virtual character is initialized. In this way, optimal positions of the joint points can be solved in the vicinity of the position data, therefore the solving difficulty is reduced, and the solving efficiency is improved, so as to achieve real-time control of the motion of the virtual character.

In some other embodiments, the joint points include the skeletal joint points and a profile joint point, wherein the skeletal joint points are the nodes connecting the bones, and the profile joint point is a virtual point set on an outer contour of the original model and the virtual character in order to avoid clipping. In some embodiments, one frame of original motion data is applied to virtual characters with the same skeleton but different outer contours. In some embodiments, the virtual doll is fat or thin, or some virtual dolls have large heads, or wear a skirt, and so on, leading to different outer contours, then more than one virtual points are set on the outer contours of the original model and the virtual character that need to avoid clipping as the profile joint points.

In S203: a target function is constructed using the initial motion data and the original motion data.

The original motion data represents the motion performed by the original model, and the initial motion data represents an initialized motion of the virtual character. In some embodiments, the initial motion data and the original motion data are substituted into the target function, and the target function is configured to calculate a similarity between the initial motion data and the original motion data, that is, to calculate a similarity between the motion performed by the original model and the motion of the virtual character.

In some embodiments, the similarity is represented by a distance between the initial motion data and the original motion data. The smaller the similarity is, the closer the motion of the virtual character is to the motion of the original model. In the target function, the original motion data is a fixed value, the initial motion data is a variable, and the target function value is a dependent variable. The target function value is minimized by continuously iteratively updating the initial motion data. In some embodiments, the target function is a function calculating the distance between two values, such as an L2 norm (Euclidean) distance function, a Chebyshev distance function, or the like. The embodiment of the present disclosure does not limit the target function for calculating the similarity.

In S204: a collision constraint between the plurality of skeletal joint points of the virtual character and the profile joint point of the virtual character is generated, and a length constraint between adjacent skeletal joint points in the plurality of skeletal joint points of the virtual character is generated with an unchanged distance between the adjacent skeletal joint points.

The bones at the same positions on the skeletons in the original model and the virtual character possibly have different lengths, and the bones at the same positions of different virtual characters have different lengths. Illustratively, the arm of virtual character A is long and the arm of virtual character B is short, but for the same virtual character, the length of each bone is fixed, and the length of each bone in the virtual character is constrained to be unchanged in some embodiments. In some embodiments, the length of each bone of the virtual character is calculated, and then the distance between two adjacent skeletal joint points forming each bone in the initial motion data is calculated. The difference between the distance and an original distance of the bone serves as the length constraint, that is, the length of the bone defined by two skeletal joint points needs to be kept unchanged when changing the positions of the skeletal joint points.

At the same time, in some embodiments, a preset skeletal joint point subjected to a collision constraint on the virtual character and a collision point (profile joint point) on the virtual character are determined, and the distance between the skeletal joint point subjected to the collision constraint and the collision point is calculated as a collision depth. In the case that the collision depth is constrained to be less than or equal to 0, it is ensured that the skeletal joint point subjected to the collision constraint does not collide with the collision point, and the motion of the virtual character is not clipped.

In S205: target motion data of the virtual character is acquired by solving a minimum distance value of the target function under the length constraint and the collision constraint, wherein the target motion data is target position data of the plurality of skeletal joint points of the virtual character.

The process of solving the minimum distance value of the target function under the length constraint and the collision constraint includes: under the condition that the bone length is unchanged and the skeletal joint point subjected to the collision constraint does not collide with the collision point, minimizing a function value of the target function by constantly changing the initial motion data, that is, the positions of the plurality of skeletal joint points of the virtual character are acquired by minimize, by constantly changing the positions of the plurality of skeletal joint points of the virtual character, the value of the target function. In practical application, a sequential quadratic programming (SQP) or augmented lagrange method (ALM) can be used to solve an optimal solution of the target function, to acquire the target position data of the skeletal joint points of the virtual character. The solving methods of the SQP or ALM can refer to the related art, and are not repeated in detail here.

In S206: the virtual character is driven to perform the target motion by controlling the plurality of skeletal joint points of the virtual character to move to positions indicated by the target position data.

Upon acquiring, by solving, the target position data of the plurality of skeletal joint points of the virtual character, the plurality of skeletal joint points on the skeleton of the virtual character are controlled to move to the positions indicated by the target position data. In the case that the plurality of skeletal joint points are located at the positions indicated by the target position data, the motion presented by the plurality of bones defined by the skeletal joint points is the target motion performed by the original model.

According to the embodiments of the present disclosure, the initial motion data of the virtual character is determined based on the original motion data upon the original motion data of the original model in the case of the original model performing the target motion being acquired, the target function is constructed using the initial motion data and the original motion data, the target function being configured to calculate the similarity between the initial motion data and the original motion data, the collision constraint between the plurality of skeletal joint points of the virtual character and the profile joint point of the virtual character is generated, the length constraint between adjacent skeletal joint points in the plurality of skeletal joint points on the virtual character is generated with the unchanged distance between the adjacent skeletal joint points, the target motion data of the virtual character is acquired by further solving the minimum distance value of the target function under the length constraint and the collision constraint, the target motion data being the target position data of the joint points of the virtual character, and finally the plurality of skeletal joint points of the virtual character are controlled to move to the positions indicated by the target position data, to drive the virtual character to perform the target motion. On one hand, the smaller the distance between the initial motion data and the original motion data is, the closer the motion of the virtual character is to the motion of the original model, which ensures that the virtual character can accurately perform the target motion made by the original model. On the other hand, through the length constraint and collision constraint, the motion semantic integrity is ensured and the clipping is avoided.

### Embodiment 2

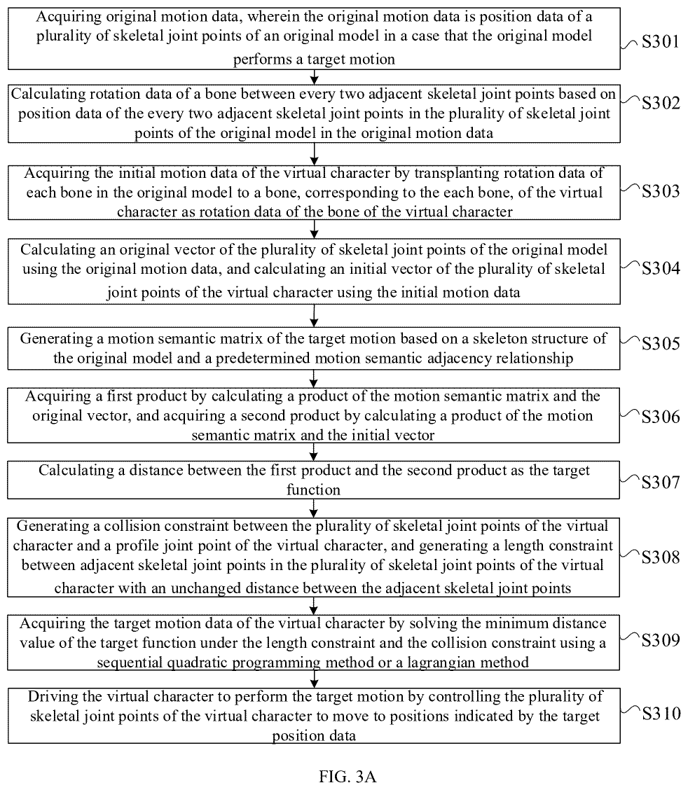

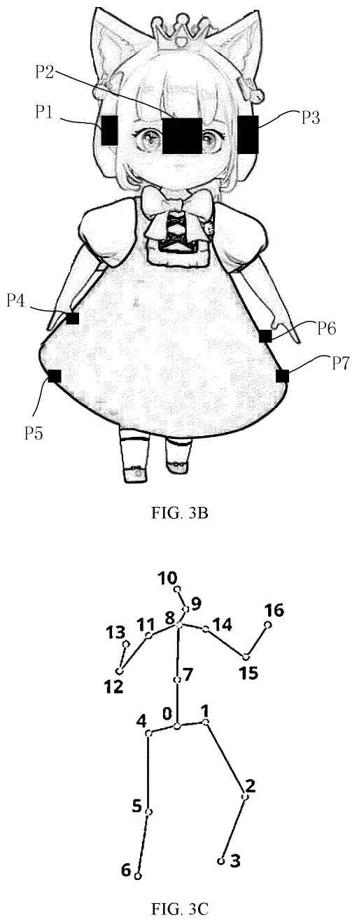

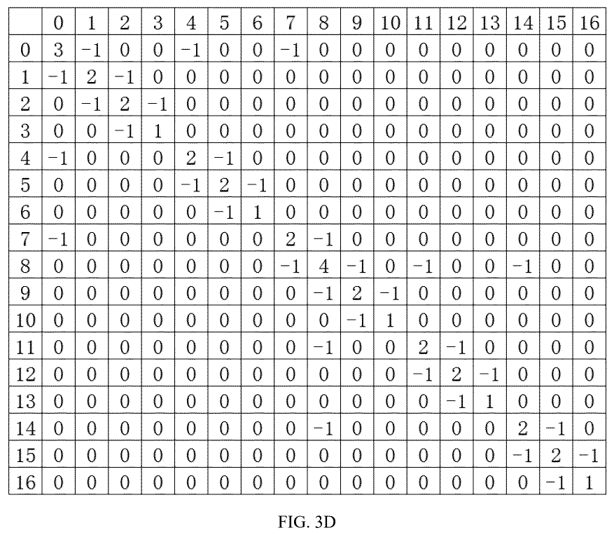

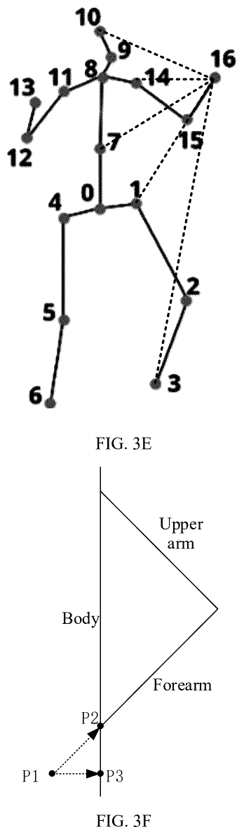

FIG. 3A is a flowchart of a method for controlling a motion of a virtual character according to Embodiment 2 of the present disclosure, which is illustrated on the basis of the preceding Embodiment 1. As shown in FIG. 3A, the method for controlling the motion of the virtual character according to the embodiments of the present disclosure includes the following processes in some embodiments. In S301: the original motion data is acquired, wherein the original motion data is the position data of the plurality of skeletal joint points of the original model in the case that the original model performs the target motion.

In the embodiments of the present disclosure, prior to acquiring the original motion data, the joint points of the original model and the virtual character are first set, and the set joint points include the skeletal joint points and the profile joint point, wherein the skeletal joint points include two nodes forming each bone, the profile joint point is a virtual joint point set according to the profile of the virtual character to avoid clipping during the motion of the virtual character, and the profile joint point is set according to different profiles of the virtual character.

In the virtual doll shown in FIG. 3B, the head of the virtual doll is relatively large and the skirt worn is relatively large in profile. In order to avoid the phenomenon of clipping caused by the hand penetrating the head or the skirt during the movement of the hand, the profile joint points are added to the head and skirt. In some embodiments, the profile joint points are added to the head, such as black squares P1, P2, and P3 at the head shown in FIG. 3B, and the profile joint points are added to the skirt, such as black squares P4, P5, P6, and P7 shown in FIG. 3B. Of course, in practical application, different profile joint points are preset according to different virtual characters, which is not limited by the embodiment of the present disclosure.

In some embodiments, when acquiring the original motion data, the image of the original model is collected, and the position data of the plurality of skeletal joint points on the original model is acquired as the original motion data by performing joint point identification on the image. In some embodiments, in the case that the original model is an anchor, at least one frame of the image of the anchor is captured by a camera and input into the pre-trained human body joint point recognition network to acquire the position data of the skeletal joint points of the anchor as the original motion data.

FIG. 3C is a schematic diagram of a human skeleton. As shown in FIG. 3, the human skeleton is composed of a plurality of bones, and two ends of each bone are the skeletal joint points. In the embodiments of the present disclosure, the motion of the model is represented by the position data of 17 skeletal joint points (point 0-point 16). In some embodiments of the present disclosure, the original motion data is the rotation data of the bones in the skeleton with the pelvis being a root bone, and other bones being child bones or secondary bones of the pelvis, and then the rotation data is the position data of each bone relative to its father bone. Illustratively, as shown in FIG. 3C, assuming that the rotation data of bone P07 relative to the skeletal joint point 0 is D07 and the rotation data of bone P78 relative to bone P07 is D78, then the rotation data of bone P78 relative to the skeletal joint point 0 is D07×D78, and so on, the rotation data of each bone relative to the skeletal joint point 0 can be acquired. Moreover, because the skeletal joint points are the nodes connecting the bones, the position data of the plurality of skeletal joint points can be determined upon the rotation data of the bones being acquired, or the rotation data of the bones defined of the skeletal joint points can also be acquired upon the position data of the plurality of skeletal joint points being acquired.

In S302: the rotation data of the bone between every two adjacent skeletal joint points is calculated based on the position data of the every two adjacent skeletal joint points in the plurality of skeletal joint points of the original model in the original motion data.

In some embodiments of the present disclosure, the position data is three-dimensional coordinates of the skeletal joint points, and the three-dimensional coordinates of the plurality of joint points relative to a human body coordinate system are acquired by the human body joint point identification. In some embodiments, in the case that an origin point of the coordinate system is the skeletal joint point 0 as shown in FIG. 3C, the three-dimensional coordinates of the plurality of skeletal joint points, from the skeletal joint point 1 to the skeletal joint point 16, relative to the skeletal joint point 0 are acquired by identification of the human body joint points, so that based on the coordinates of two skeletal joint points forming each bone, the rotation data of the bone relative to the father bone is calculated.

As shown in FIG. 3C, taking the skeletal joint point 0 of the pelvis as the coordinate origin point, upon acquiring the three-dimensional coordinates of the skeletal joint point 0 and the skeletal joint point 7, the rotation data of the bone P07 is calculated based on the three-dimensional coordinates of the skeletal joint point 7 and the skeletal joint point 0, then the rotation data of the bone P78 relative to its father bone P07 is calculated based on the three-dimensional coordinates of the skeletal joint point 8 and the skeletal joint point 7, the rotation data of the bone P78 relative to the skeletal joint point 0 is acquired by multiplying the rotation data of the bone P07 and the rotation data of the bone P78, and so on, to acquire the rotation data of the plurality of bones relative to the skeletal joint point 0.

In S303: initial motion data of the virtual character is acquired by transplanting the rotation data of each bone in the original model to a bone, corresponding to the each bone, of the virtual character as the rotation data of the bone of the virtual character.

The original motion data represents the target motion made by the original model, and the original motion data is assigned to the bones of the virtual character in some embodiments, that is, the plurality of bones of the virtual character are initialized, such that the plurality of bones of the virtual character have the same rotation data as the corresponding bones in the original model, that is, the position data of the plurality of skeletal joint points of the virtual character is initialized. In this way, the optimal positions of the skeletal joint points can be solved in the vicinity of the position data, thereby reducing the difficulty of solving and improving the efficiency of solving, to achieve controlling the motion of the virtual character in real-time.

In some embodiments, for the virtual character, the rotation data of each bone is set in sequence with the skeletal joint point 0 of the pelvis as the origin point, making the rotation data of each bone of the virtual character the same as the rotation data of the corresponding bone in the original model, and the initialized position of each skeletal joint point of the virtual character is acquired. Therefore, the optimal positions of the skeletal joint points can be solved in the vicinity of the initial positions, reducing the difficulty of solving and improving the efficiency of solving to achieve controlling the motion of the virtual character in real-time.

In S304: an original vector of the plurality of skeletal joint points of the original model is calculated using the original motion data, and an initial vector of the plurality of skeletal joint points of the virtual character is calculated using the initial motion data.

In some embodiments, the three-dimensional coordinates of the plurality of skeletal joint points are calculated based on the rotation data of the bones, and the three-dimensional coordinates of the plurality of skeletal joint points are connected into one vector, that is, the vector of all skeletal joint points of the model. As shown in FIG. 3C, there is a total of 17 skeletal joint points, each skeletal joint point has coordinate values of three dimensions x, y, and z, and then a vector x∈R\hat{ }51 is acquired based on all skeletal joint points of the model.

In S305: a motion semantic matrix of the target motion is generated based on a skeleton structure of the original model and a predetermined motion semantic adjacency relationship.

In some embodiments of the present disclosure, a joint point adjacency matrix of the original model is acquired, and each element value in the row where each skeletal joint point is located in the joint point adjacency matrix represents a joint adjacency relationship of the skeletal joint point with other skeletal joint points. For each target skeletal joint point of the original model, a motion semantic adjacent joint point of the target skeletal joint point is determined based on the predetermined motion semantic adjacency relationship, and an element value of the motion semantic adjacent joint point in the row where the target skeletal joint point is located in the joint point adjacency matrix is updated to acquire the motion semantic matrix of the target motion. In some embodiments, the target skeletal joint point is defined as the skeletal joint point, that needs more attention, in a motion of the original model, and is generally the skeletal joint point, for transmitting motion information, of the arm, hand, and other bones of the original model.

The joint point adjacency matrix represents an adjacency relationship between the skeletal joint points in the model. As shown in FIG. 3C, the skeletal joint point 8 is respectively adjacent to the skeletal joint point 11, the skeletal joint point 9, the skeletal joint point 14, and the skeletal joint point 7, and the skeletal joint point 8 is not adjacent to other skeletal joint points. In the case that two skeletal joint points are adjacent, the element value of a corresponding element in the joint point adjacency matrix is denoted as −1. In the case that two skeletal joint points are not adjacent, the element value of a corresponding element in the joint point adjacency matrix is denoted as 0. FIG. 3D is the joint point adjacency matrix of the plurality of skeletal joint points in FIG. 3C. For ease of identification, the matrix is tabulated. In FIG. 3D, the first row and the first column are serial numbers of the skeletal joint points. Taking the skeletal joint point 8 as an example, in the row where the skeletal joint point 8 is located, because the skeletal joint point 8 is adjacent to the skeletal joint point 11, the skeletal joint point 9, the skeletal joint point 14, and the skeletal joint point 7, the corresponding element values are −1; the skeletal joint point 8 has four adjacent skeletal joint points, then the element value corresponding to the row and column where the skeletal joint point 8 is located is 4; and the element values corresponding to other non-adjacent skeletal joint points are 0. As can be seen from FIG. 3D, the diagonal in the joint point adjacency matrix represents the number of the skeletal joint points adjacent to each skeletal joint point.

The predetermined motion semantic adjacency relationship represents an adjacency relationship between the skeletal joint points in one motion, that is, the semantics of the motion is represented by the defined adjacency relationship of the skeletal joint points. As shown in FIG. 3E, taking the hand motion as an example, the adjacency relationship of the skeletal joint point 16 of the hand with other skeletal joint points is defined in advance. In some embodiments, the skeletal joint point 16 of the hand is defined to be adjacent to a total of five skeletal joint points, namely, the skeletal joint point 10 of the head, the skeletal joint point 14 of the shoulder, the skeletal joint point 7 of the spine, the skeletal joint point 1 of the thigh, and the skeletal joint point 3 of the foot respectively. In some embodiments, similar to the joint point adjacency matrix, the predetermined motion semantic adjacency relationship is also tabulated, and then the element values of the row where the skeletal joint point 16 is located in the table corresponding to the predetermined motion semantic adjacency relationship are as follows:

TABLE 1

| | | | | | | | | | | | | | | | | |
|---|---|---|---|---|---|---|---|---|---|---|---|---|---|---|---|---|
| 0 | −1 | 0 | −1 | 0 | 0 | 0 | −1 | 0 | 0 | −1 | 0 | 0 | 0 | −1 | 0 | 5 |

Because the element value is −1 in the case that two skeletal joint points are adjacent and the element value is 0 in the case that two skeletal joint points are not adjacent, a motion semantic connection relationship of the skeletal joint point 16 can be seen from the row where the skeletal joint point 16 is located. In some embodiment, for the skeletal joint points in the original model and the virtual character, the motion semantic adjacency relationship of each skeletal joint point is defined in advance. As shown in FIG. 3C, it is defined that the skeletal joint point 16 of the hand is adjacent to the total of five skeletal joint points, namely, the skeletal joint point 10 of the head, the skeletal joint point 14 of the shoulder, the skeletal joint point 7 of the spine, the skeletal joint point 1 of the thigh, and the skeletal joint point 3 of the foot. In this case, more attention is paid to the hand motion, therefore, the skeletal joint point 16 of the hand is defined to be adjacent, in motion semantic, to other relatively fixed skeletal joint points. In some embodiment, in the case that more attention is paid to the head motion, then the skeletal joint point 10 of the head is defined to be adjacent, in motion semantic, to the skeletal joint point 8, the skeletal joint point 11, the skeletal joint point 14, and the skeletal joint point 7 respectively. The embodiments of the present disclosure do not limit the motion semantic adjacency relationship of the skeletal joint points.

Table 1 above is a representation, in matrix form, of the motion semantic connection relationship of the skeletal joint point 16. The element values in Table 1 are updated into the matrix as shown in FIG. 3D, and the element values of the rows where other skeletal joint points are located are updated by analogy, to acquire the motion semantic matrix of the target motion. This motion semantic matrix represents the motion adjacency relationship of each skeletal joint point in the case of the original model performing the target motion, that is, the motion adjacency relationship of two skeletal joint points connected by the dotted line in FIG. 3E, and the whole motion semantic matrix represents the motion semantics of the motion made by the original model.

In some embodiments, upon setting the element value of the motion semantic adjacent joint point in the row where the target skeletal joint point is located in the joint point adjacency matrix to a predetermined value, the distances between the plurality of motion semantic adjacent joint points and the target skeletal joint point are calculated, a weight of each motion semantic adjacent joint point is calculated using the distance, a weighted value is acquired by calculating a product of the weight of each motion semantic adjacent joint point and the predetermined value, and the element value of the motion semantic adjacent joint point in the row where the target skeletal joint point is located in the joint point adjacency matrix is modified to be equal to the weighted value.

As shown in FIG. 3D, because the skeletal joint point 16 is respectively adjacent, in motion semantics, to the total of five skeletal joint points, namely the skeletal joint point 10 of the head, the skeletal joint point 14 of the shoulder, the skeletal joint point 7 of the spine, the skeletal joint point 1 of the thigh, and the skeletal joint point 3 of the foot, the element values of the skeletal joint point 10 of the head, the skeletal joint point 14 of the shoulder, the skeletal joint point 7 of the spine, the skeletal joint point 1 of the thigh, and the skeletal joint point 3 of the foot in the row where the skeletal joint point 16 is located in FIG. 3D are changed into the values in Table 1 above. That is, upon changing to the predetermined value −1, the distance between each of the skeletal joint point 10, the skeletal joint point 14, the skeletal joint point 7, the skeletal joint point 1, and the skeletal joint point 3 in the original model and the skeletal joint point 16 is calculated, wherein in some embodiments, the distance between two skeletal joint points is calculated based on the three-dimensional coordinates of the two skeletal joint points; then a reciprocal of each distance is calculated, and a sum of all the reciprocals is calculated. For each of the skeletal joint point 10, the skeletal joint point 14, the skeletal joint point 7, the skeletal joint point 1, and the skeletal joint point 3, a ratio of the reciprocal of the distance of the each skeletal joint point to the sum of the reciprocals is calculated as the weight of the skeletal joint point, which is shown by the following formula:

$${w}_{j} = \frac{\frac{1}{Distance\_ij}}{\sum \frac{1}{Distance\_ij}} .$$

In the above formula, Distance_ij represents the distance from the skeletal joint point j, which is adjacent to the skeletal joint point i in motion semantics, to the skeletal joint point i, and wⱼ represents the weight of the skeletal joint point j. It can be seen that the greater the distance between the skeletal joint point j and the skeletal joint point i, the smaller the weight of the skeletal joint point j. As shown in FIG. 3E, the distance between the skeletal joint point 3 of the foot and the skeletal joint point 16 of the hand is the largest. In the case that the hand performs the target motion, the semantic relationship between the skeletal joint point 16 and the foot is lesser, that is, the hand motion has little relationship with the joint of the foot, and on the contrary, the skeletal joint point 16 has the strongest relationship with the skeletal joint point 14 of the shoulder. In this way, the distance between skeletal joint points that are adjacent in motion semantics is dynamically calculated for different motions to determine the weight of the skeletal joint point, thereby better illustrating the motion semantics through the weight.

Upon acquiring the weight of the skeletal joint point, the weighted value acquired by multiplying the weight with the element value corresponding to the skeletal joint point is taken as a new element value. Taking Table 1 above as an example, upon calculation, assuming that the weights of the skeletal joint point 16 with the skeletal joint points 1, 3, 7, 10, and 14 respectively are 0.1, 0.2, 0.2, 0.2, and 0.3, then Table 1 above is updated as follows:

| | | | | | | | | | | | | | | | | |
|---|---|---|---|---|---|---|---|---|---|---|---|---|---|---|---|---|
| 0 | −0.1 | 0 | −0.2 | 0 | 0 | 0 | −0.2 | 0 | 0 | −0.2 | 0 | 0 | 0 | −0.3 | 0 | 1 |

The weighted motion semantic matrix is acquired by updating the weighted values of all skeletal joint points. Concerning different motions, the distances of the plurality of skeletal joint points are different, and the weights are also different. The greater the distance, the smaller the weight, and the smaller the distance, the greater the weight. By dynamically allocating the weights, the motion semantic matrix better illustrates the motion semantics.

In S306: a first product is acquired by calculating a product of the motion semantic matrix and the original vector and a second product is acquired by calculating a product of the motion semantic matrix and the initial vector.

The motion semantic matrix of the target motion in S305 is denoted as L, the vector defined by the positions of all skeletal joint points of the original model in S304 is denoted as srcPos3d, and the vector defined by the positions of all skeletal joint points of the virtual character is denoted as tarPos3d, then the first product LxsrcPos3d is calculated and the second product LxtarPos3d is calculated, wherein the first product represents a measurement value of the adjacency relationship of each skeletal joint point in the original model in motion semantics, and the second product represents a measurement value of the adjacency relationship of each skeletal joint point in the virtual character in motion semantics.

In S307: a distance between the first product and the second product is calculated as the target function.

### In Some Embodiments, the Target Function is as Follows:

$$min 0.5 \times {‖ L \times tarPos 3 d - L \times s r c Pos 3 d ‖}^{2} ,$$

wherein Z represents the motion semantic matrix of the target motion, tarPos3d represents the initial vector of the plurality of skeletal joint points of the virtual character, srcPos3d represents the original vector of the plurality of skeletal joint points of the original model, and ∥·∥² is a two-norm distance. The smaller the value of the target function is, the closer the virtual character is to the original model in motion semantics.

In S308: the collision constraint between the plurality of skeletal joint points of the virtual character and the profile joint point of the virtual character is generated, and the length constraint between adjacent skeletal joint points in the plurality of skeletal joint points of the virtual character is generated with the unchanged distance between the adjacent skeletal joint points.

In some embodiments, for the length constraint, the distance between two skeletal joint points of each bone of the virtual character is calculated as an original length of the bone, the distance between the vectors of two skeletal joint points of each bone is calculated, and the length constraint is constructed as follows:

$$‖ tarPos 3 d [ i ] - t a r Pos 3 d [ j ] ‖ - resetLength = 0 ,$$

wherein resetLength represents the original length of the bone between the skeletal joint point i and the skeletal joint point j of the virtual character, and tarPos3d[i] and tarPos3d[j] respectively represent the vectors of the skeletal joint point i and the skeletal joint point j. This length constraint means that the distance between the changed skeletal joint point i and the changed skeletal joint point j is equal to the original length resetLength in the case of the position of the skeletal joint point i and the position of the skeletal joint point j being constantly changed in the process of solving the minimum value of the target function, wherein i and j are both integers greater than or equal to 0.

For the collision constraint, the profile joint point includes a predetermined collision point, the skeletal joint points include a joint point subjected to the collision constraint, and the collision constraint between the plurality of skeletal joint points of the virtual character and the profile joint point of the virtual character is generated as follows:

$$( t a r P o s 3 d [ i ] - collPos ) . dot ( colldepth ) \leq 0 ,$$

wherein collPos represents the vector of the collision point, tarPos3d[i] represents the vector of the joint point i subjected to the collision constraint, tarPos3d[i]-collPos represents the vector from the joint point i subjected to the collision constraint to the predetermined collision point, and dot product .dot(colldepth) represents a projection, in a direction perpendicular to the outer contour of the virtual character, of the vector from the joint point i subjected to the collision constraint to the predetermined collision point, wherein i is an integer greater than or equal to 0. The collision constraint means that a distance of the projection, in the direction perpendicular to the outer contour of the virtual character, from the changed joint point i subjected to the collision constraint to the predetermined collision point is less than or equal to 0 in the case of the joint point i subjected to the collision constraint being constantly changed in the process of solving the minimum value of the target function.

The principle of the collision constraint is shown in FIG. 3F. In FIG. 3F, in order to prevent the phenomenon of clipping that the human hand penetrates the body in the case that the human body rests the hands on hips, the profile joint point P2 is set on the body as the collision point, and the skeletal joint point P1 of the hand at the tail end of the forearm serves as the skeletal joint point subject to the collision constraint (collision constraint joint point). The distance of the projection, in the direction perpendicular to the outer surface of the body, of the vector from the skeletal joint point P1 to the profile joint point P2 is the distance from P1 to P3, that is, the collision depth. The collision depth being less than or equal to 0 means that the skeletal joint point P1 does not collide with the profile joint point P2, that is, the hand will not penetrate the body, thereby ensuring that the phenomenon of clipping is prevented.

In S309: the target motion data of the virtual character is acquired by solving the minimum distance value of the target function under the length constraint and the collision constraint using the sequential quadratic programming method or a lagrangian method.

### Solving the Target Motion Data Means Solving the Following Target Function:

$$min 0.5 \times {‖ L \times tarPos 3 d - L \times s r c Pos 3 d ‖}^{2} ,$$

$$Subject to : \{ \begin{matrix}‖ tarPos 3 d [ i ] - tarPos 3 d [ j ] ‖ - resetLength = 0 \\ ( tarPos 3 d [ i ] - collPos ) . dot ( colldepth ) \leq 0\end{matrix} .$$

That is, by constantly changing the position of the skeletal joint point of the virtual character, the vector tarPos3d of the skeletal joint point of the virtual character is changed, and until ∥L×tarPos3d−L×srcPos3d∥² is the minimum, the position of the skeletal joint point is the optimal position. In the process of changing the position of the skeletal joint point, it is necessary to ensure that the distance between the two skeletal joint points i and j forming the bone is always unchanged, and the skeletal joint point i subjected to collision constraint does not collide with the collision point.

In practical application, the sequential quadratic programming (SQP) method or an augmented lagrange method (ALM) is used to solve the optimal solution of the target function in some embodiments, that is, the target position data of the skeletal joint points of the virtual character are acquired. The solving methods of the sequential quadratic programming (SQP) method or an augmented lagrange method (ALM) can refer to the related art.

In some embodiments, for one target motion, the motion semantic matrix L is fixed and the collision constraint is that the collision depth is equal to 0, then the target function is simplified as a function of equality constraint:

$$min 0.5 \times {‖ tarPos 3 d - srcPos 3 d ‖}^{2} ,$$

$$Subject to : \{ \begin{matrix}‖ tarPos 3 d [ i ] - tarPos 3 d [ j ] ‖ - resetLength = 0 \\ ( tarPos 3 d [ i ] - collPos ) . dot ( colldepth ) \leq 0\end{matrix} .$$

The solving process includes the following.

Assuming that C(tarPos3d)=∥tarPos3d[i]−tarPos3d[j] ∥−resetLength, C(tarPos3d) being quadratic equality nonlinear constraint, C(tarPos3d) is subjected to Taylor expansion for first-order linear transformation to get:

$$C ( t a r P o s 3 d ) = J \times t a r P o s 3 d - b ,$$

wherein J represents the Jacobian matrix of C(tarPos3d), and b represents the constant upon Taylor expansion. Taylor expansion can refer to the related art and is not repeated in detail here.

Because the motion semantic matrix is fixed upon the motion being determined, a lagrange function is constructed:

$$min 0.5 \times ‖ tarPos 3 d - s r c P o s3d ‖ + λ \times ( J \times t a r P o s 3 d - b ) .$$

Assuming that x=tarPos3d-srcPos3d, then the lagrange function is transformed into:

$$L ( x , λ ) = 0 \text{.5} \times ‖ x ‖ + transpose ( λ ) \times ( J \times x - b ) \qquad ( 1 )$$

wherein transpose (·) means transpose of a matrix.

Let derivatives of Formula (1) to x and λ be equal to 0 respectively, and the following equation set is acquired:

$$x + transpose ( J ) \times λ = 0 \qquad ( 2 )$$

$$J \times x = b \qquad ( 3 )$$

### The Following Formula is Acquired by Transforming Formula (2):

$$x = - transpose ( J ) \times λ \qquad ( 4 )$$

The Following Formula is Acquired by Substituting Formula (4) into Formula (3):

$$J \times ( - transpose ( J ) \times λ ) = b \qquad ( 5 )$$

### λ Is Solved:

$$λ = \frac{- b}{J \times transpose ( J )} \qquad ( 6 )$$

Formula (6) is Substituted into Formula (2) to Solve x:

$$x = \frac{transpose ( J ) \times b}{J \times transpose ( J )} \qquad ( 7 )$$

wherein x is iterated by a Gauss-Seidel iteration method until reaching the convergence to acquire the final x. Because x=tarPos3d-srcPos3d, srcPos3d being fixed, thus tarPos3d, i.e., the optimal position of the skeletal joint point of the virtual character, is acquired. The iteration process can refer to the iteration process of the Gauss-Seidel iteration method of the related art, which is not repeated in detail here.

In S310: the virtual character is driven to perform the target motion by controlling the plurality of skeletal joint points of the virtual character to move to the positions indicated by the target position data.

Upon acquiring, by solving, the target position data of the plurality of skeletal joint points of the virtual character, the plurality of skeletal joint points on the skeleton of the virtual character are controlled to move to the positions indicated by the target position data. In the case that the plurality of skeletal joint points are disposed at the positions indicated by the target position data, the motion presented by the plurality of bones defined by the skeletal joint points is the target motion performed by the original model.

According to the embodiments of the present disclosure, the initial motion data of the virtual character is determined based on the original motion data upon the original motion data of the original model, in the case of the original model performing the target motion, being acquired. The original vector of the skeletal joint points of the original model is calculated using the original motion data, and the initial vector of the skeletal joint points of the virtual character is calculated using the initial motion data. Based on the skeleton structure of the original model and the predetermined motion semantic adjacency relationship, the motion semantic matrix of the target motion is generated, the products of the motion semantic matrix with the original vector and the motion semantic matrix with the initial vector are respectively calculated to acquire the first product and the second product, and the distance between the first product and the second product is calculated as the target function. The collision constraint between the plurality of skeletal joint points of the virtual character and the profile joint point of the virtual character is generated, the length constraint between adjacent skeletal joint points in the plurality of skeletal joint points of the virtual character is generated with the unchanged distance between the adjacent skeletal joint points, and then the minimum distance value of the target function under the length constraint and the collision constraint is solved to acquire the target motion data of the virtual character, the target motion data being the target position data of the plurality of skeletal joint points of the virtual character. Finally, the plurality of skeletal joint points of the virtual character are controlled to move to the positions indicated by the target position data, to achieve driving the virtual character to perform the target motion. On one hand, the smaller the distance between the initial motion data and the original motion data is, the closer the motion of the virtual character is to the motion of the original model, which ensures that the virtual character can accurately perform the target motion made by the original model. On the other hand, through the length constraint and collision constraint, the motion semantic integrity can be ensured and the clipping is avoided.

### Embodiment 3

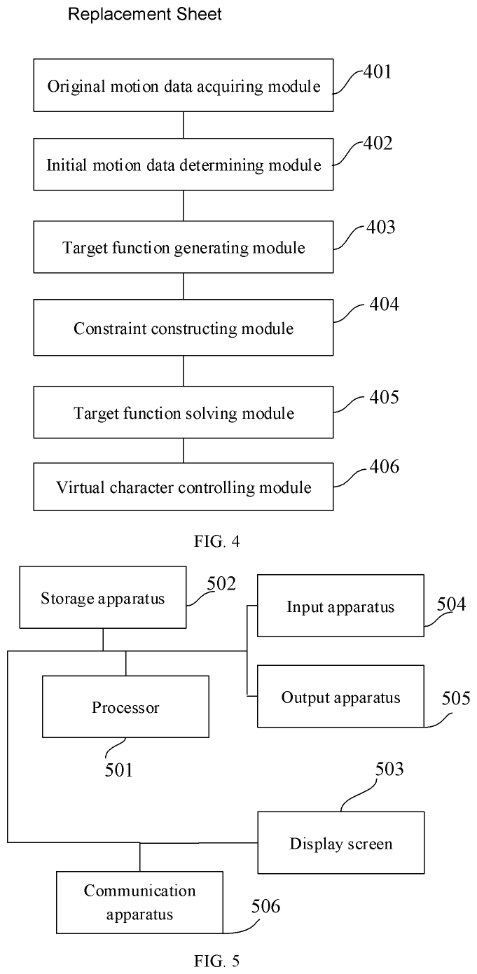

FIG. 4 is a structural block diagram of an apparatus for controlling a motion of a virtual character according to Embodiment 3 of the present disclosure. As shown in FIG. 4, the apparatus for controlling the motion of the virtual character according to the embodiments of the present disclosure specifically includes the following modules: an original motion data acquiring module 401, configured to acquire original motion data, wherein the original motion data is position data of a plurality of skeletal joint points of an original model in a case that the original model performs a target motion; an initial motion data determining module 402, configured to determine initial motion data of the virtual character based on the original motion data, wherein the initial motion data is initial position data of a plurality of skeletal joint points of the virtual character; a target function generating module 403, configured to construct a target function using the initial motion data and the original motion data, wherein the target function is configured for calculating a similarity between the initial motion data and the original motion data; a constraint constructing module 404, configured to generate a collision constraint between the plurality of skeletal joint points of the virtual character and a profile joint point of the virtual character, and generate a length constraint between adjacent skeletal joint points in the plurality of skeletal joint points of the virtual character with an unchanged distance between the adjacent skeletal joint points; a target function solving module 405, configured to acquire target motion data of the virtual character by solving a minimum distance value of the target function under the length constraint and the collision constraint, wherein the target motion data is target position data of the plurality of skeletal joint points of the virtual character; and a virtual character controlling module 406, configured to drive the virtual character to perform the target motion by controlling the plurality of skeletal joint points of the virtual character to move to positions indicated by the target position data.

The apparatus for controlling the motion of the virtual character according to the embodiments of the present disclosure is capable of performing the methods for controlling the motion of the virtual character according to Embodiment 1 and Embodiment 2 of the present disclosure, and has corresponding functional modules for executing the methods.

### Embodiment 4

Referring to FIG. 5, a structural schematic diagram of a device for controlling a motion of a virtual character according to some embodiments of the present disclosure is shown. As shown in FIG. 5, the device for controlling the motion of the virtual character includes a processor 501, a storage apparatus 502, a display screen 503 with a touch function, an input apparatus 504, an output apparatus 505, and a communication apparatus 506. The number of the processors 501 in the device for controlling the motion of the virtual character is one or more, and one processor 501 is shown in FIG. 5 as an example. The processor 501, the storage apparatus 502, the display screen 503, the input apparatus 504, the output apparatus 505, and the communication apparatus 506 of the device for controlling the motion of the virtual character are connected by a bus or other means, and the bus connection is shown in FIG. 5 as an example. The device for controlling the motion of the virtual character is configured to perform the methods for controlling the motion of the virtual character according to the embodiments of the present disclosure.

### Embodiment 5

The embodiments of the present disclosure provide a computer-readable storage medium storing a computer program, wherein the computer program, when executed by a processor, causes the processor to perform the method for controlling the motion of the virtual character according to the above method embodiments.

### Embodiment 6

The embodiments of the present disclosure provide a computer program product including one or more instructions, wherein the one or more instructions, when loaded and executed by a processor, cause the processor to perform the method for controlling the motion of the virtual character according to the above method embodiments.

In terms of the present disclosure, the computer-readable storage medium is any of the apparatuses that contain, store, communicate, propagate, or transmit a program for use by or in combination with an instruction execution system, apparatus, or device. Examples (non-exhaustive list) of the computer-readable medium include the following: an electrical connection part (electronic apparatus) with one or more wires, a portable computer disk box (magnetic apparatus), a random access memory (RAM), a read-only memory (ROM), an erasable programmable read-only memory (EPROM) or a flash memory, an optical fiber apparatus, and a portable compact disk read-only memory (CD-ROM). In addition, the computer-readable medium can even be paper or other suitable mediums on which the program can be printed, because the program can be acquired electronically by, such as, optically scanning the paper or other mediums, followed by editing, interpreting, or processing in other suitable ways in necessary cases, and then be stored in a computer memory. In some embodiments, the computer program product is a product containing the computer-readable storage medium, such that the instructions in the computer-readable storage medium, when loaded and executed by a processor, cause the processor to perform the methods for controlling the motion of the virtual character according to the above method embodiments.

It should be noted that the descriptions for the apparatus, the device, the storage medium, and the computer program product embodiments are relatively simple due to the total similarity to the method embodiments, and the relevant parts can refer to part of illustrations of the method embodiments.

1. A method for controlling a motion of a virtual character, the method comprising:
acquiring original motion data, wherein the original motion data is position data of a plurality of skeletal joint points of an original model in a case that the original model performs a target motion;
determining initial motion data of the virtual character based on the original motion data, wherein the initial motion data is initial position data of a plurality of skeletal joint points of the virtual character;
constructing a target function using the initial motion data and the original motion data, wherein the target function is configured for calculating a similarity between the initial motion data and the original motion data;
generating a collision constraint between the plurality of skeletal joint points of the virtual character and a profile joint point of the virtual character, and generating a length constraint between adjacent skeletal joint points in the plurality of skeletal joint points of the virtual character with an unchanged distance between the adjacent skeletal joint points;
acquiring target motion data of the virtual character by solving a minimum distance value of the target function under the length constraint and the collision constraint, wherein the target motion data is target position data of the plurality of skeletal joint points of the virtual character; and
driving the virtual character to perform the target motion by controlling the plurality of skeletal joint points of the virtual character to move to positions indicated by the target position data.

2. The method according to claim 1, wherein prior to acquiring the original motion data, the method further comprises:
setting joint points, wherein the joint points comprise the plurality of skeletal joint points of the original model, and the profile joint point and the plurality of skeletal joint points of the virtual character.

3. The method according to claim 1, wherein acquiring the original motion data comprises:
collecting an image of the original model; and
acquiring, by performing joint point identification on the image, the position data of the plurality of skeletal joint points of the original model as the original motion data.

4. The method according to claim 1, wherein determining the initial motion data of the virtual character based on the original motion data comprises:
calculating rotation data of a bone between every two adjacent skeletal joint points based on position data of the every two adjacent skeletal joint points in the plurality of skeletal joint points of the original model in the original motion data; and
acquiring the initial motion data of the virtual character by transplanting rotation data of each bone in the original model to a bone, corresponding to the each bone, of the virtual character as rotation data of the bone of the virtual character.

5. The method according to claim 1, wherein constructing the target function using the initial motion data and the original motion data comprises:
calculating an original vector of the plurality of skeletal joint points of the original model using the original motion data, and calculating an initial vector of the plurality of skeletal joint points of the virtual character using the initial motion data;
generating a motion semantic matrix of the target motion based on a skeleton structure of the original model and a predetermined motion semantic adjacency relationship;
acquiring a first product by calculating a product of the motion semantic matrix and the original vector, and acquiring a second product by calculating a product of the motion semantic matrix and the initial vector; and
calculating a distance between the first product and the second product as the target function.

6. The method according to claim 5, wherein generating the motion semantic matrix of the target motion based on the skeleton structure of the original model and the predetermined motion semantic adjacency relationship comprises:
acquiring a joint point adjacency matrix of the original model, wherein each element value in a row where each skeletal joint point is located in the joint point adjacency matrix represents a joint adjacency relationship of the each skeletal joint point with one of other skeletal joint points;
determining a motion semantic adjacent joint point of each target skeletal joint point of the original model based on a predetermined motion semantic adjacency relationship of the each target skeletal joint point, wherein the predetermined motion semantic adjacency relationship of the each target skeletal joint point comprises a predefined adjacency relationship of the target skeletal joint point with other skeletal joint points; and
acquiring the motion semantic matrix of the target motion by updating an element value of the motion semantic adjacent joint point in a row where the each target skeletal joint point is located in the joint point adjacency matrix.

7. The method according to claim 6, wherein a number of the motion semantic adjacent joint points of each target skeletal joint point is greater than one; and
acquiring the motion semantic matrix of the target motion by updating the element value of the motion semantic adjacent joint point in the row where the each target skeletal joint point is located in the joint point adjacency matrix comprises:
setting an element value of each of the motion semantic adjacent joint points in the row where the each target skeletal joint point is located in the joint point adjacency matrix as a predetermined value;
calculating a distance between the each of the motion semantic adjacent joint points in the row where the each target skeletal joint point is located and the each target skeletal joint point;
calculating a weight of the each of the motion semantic adjacent joint points in the row where the each target skeletal joint point is located using the distance;
acquiring a weighted value by calculating a product of the weight of the each of the motion semantic adjacent joint points in the row where the each target skeletal joint point is located and the predetermined value; and
updating the element value of the each of the motion semantic adjacent joint points in the row where the each target skeletal joint point is located in the joint point adjacency matrix as the weighted value.

8. The method according to claim 7, wherein calculating the weight of the each of the motion semantic adjacent joint points in the row where the each target skeletal joint point is located using the distance comprises:
calculating a reciprocal of the distance between the each of the motion semantic adjacent joint points in the row where the each target skeletal joint point is located and the each target skeletal joint point;
calculating a sum of all reciprocals corresponding to all of the motion semantic adjacent joint points in the row where the each target skeletal joint point is located; and
calculating a ratio of the reciprocal corresponding to the each of the motion semantic adjacent joint points in the row where the each target skeletal joint point is located to the sum as the weight of the each of the motion semantic adjacent joint points.

9. The method according to claim 5, wherein the distance between the first product and the second product is calculated as the target function by the following formula:
min 0.5×∥L×tarPos3d−L×srcPos3d∥²,
wherein L represents the motion semantic matrix, tarPos3d represents the initial vector of the plurality of skeletal joint points of the virtual character, srcPos3d represents the original vector of the plurality of skeletal joint points of the original model, and ∥·∥² represents a two-norm distance.

10. The method according to claim 5, wherein generating the length constraint between the adjacent skeletal joint points in the plurality of skeletal joint points of the virtual character with the unchanged distance between the adjacent skeletal joint points comprises:
calculating a distance between two skeletal joint points of each bone of the virtual character as an original length of the each bone;
calculating a distance of vectors of the two skeletal joint points of the each bone; and
constructing the length constraint as follows:
∥tarPos3d[i]−tarPos3d[j]∥−resetLength=0,
wherein resetLength represents an original length of a bone between two adjacent skeletal joint points i and j of the virtual character, tarPos3d[i] and tarPos3d[j] respectively represent vectors of the skeletal joint point i and the skeletal joint point j, and both i and j are integers greater than or equal to 0.

11. The method according to claim 5, wherein the profile joint point comprises a predetermined collision point, the skeletal joint points comprise a joint point subjected to the collision constraint, and the collision constraint between the plurality of skeletal joint points of the virtual character and the profile joint point of the virtual character is generated as follows:
(tarPos3d[i]−collPos)·dot(colldepth)≤0,
wherein collPos represents a vector of the predetermined collision point, tarPos3d[i] represents a vector of a joint point i subjected to the collision constraint, tarPos3d[i]−collPos represents a vector from the joint point i subjected to the collision constraint to the predetermined collision point, dot product .dot(colldepth) represents a projection, in a direction perpendicular to an outer contour of the virtual character, of the vector from the joint point i subjected to the collision constraint to the predetermined collision point, and i is an integer greater than or equal to 0.

12. The method according to claim 1, wherein acquiring the target motion data of the virtual character by solving the minimum distance value of the target function under the length constraint and the collision constraint comprises:
acquiring the target motion data of the virtual character by solving the minimum distance value of the target function under the length constraint and the collision constraint using a sequential quadratic programming method or a lagrangian method.

13. (canceled)

14. A device for controlling a motion of a virtual character, the device comprising:
at least one processor; and
a storage apparatus, configured to store at least one computer program,
wherein the at least one computer program, when executed by the at least one processor, causes the at least one processor to perform;
acquiring original motion data, wherein the original motion data is position data of a plurality of skeletal joint points of an original model in a case that the original model performs a target motion;
determining initial motion data of the virtual character based on the original motion data, wherein the initial motion data is initial position data of a plurality of skeletal joint points of the virtual character;
constructing a target function using the initial motion data and the original motion data, wherein the target function is configured for calculating a similarity between the initial motion data and the original motion data;
generating a collision constraint between the plurality of skeletal joint points of the virtual character and a profile joint point of the virtual character, and generating a length constraint between adjacent skeletal joint points in the plurality of skeletal joint points of the virtual character with an unchanged distance between the adjacent skeletal joint points;
acquiring target motion data of the virtual character by solving a minimum distance value of the target function under the length constraint and the collision constraint, wherein the target motion data is target position data of the plurality of skeletal joint points of the virtual character; and
driving the virtual character to perform the target motion by controlling the plurality of skeletal joint points of the virtual character to move to positions indicated by the target position data.

15. A non-transitory computer-readable storage medium storing a computer program, wherein the computer program, when executed by a processor, causes the processor to perform;
acquiring original motion data, wherein the original motion data is position data of a plurality of skeletal joint points of an original model in a case that the original model performs a target motion;
determining initial motion data of the virtual character based on the original motion data, wherein the initial motion data is initial position data of a plurality of skeletal joint points of the virtual character;
constructing a target function using the initial motion data and the original motion data, wherein the target function is configured for calculating a similarity between the initial motion data and the original motion data;
generating a collision constraint between the plurality of skeletal joint points of the virtual character and a profile joint point of the virtual character, and generating a length constraint between adjacent skeletal joint points in the plurality of skeletal joint points of the virtual character with an unchanged distance between the adjacent skeletal joint points;
acquiring target motion data of the virtual character by solving a minimum distance value of the target function under the length constraint and the collision constraint, wherein the target motion data is target position data of the plurality of skeletal joint points of the virtual character; and
driving the virtual character to perform the target motion by controlling the plurality of skeletal joint points of the virtual character to move to positions indicated by the target position data.

16. A computer program product comprising one or more instructions, wherein the one or more instructions, when loaded and executed by a processor, cause the processor to perform the method for controlling the motion of the virtual character as defined in claim 1.

17. The device according to claim 14, wherein the at least one computer program, when executed by the at least one processor, causes the at least one processor to perform:
setting joint points, wherein the joint points comprise the plurality of skeletal joint points of the original model, and the profile joint point and the plurality of skeletal joint points of the virtual character.

18. The device according to claim 14, wherein the at least one computer program, when executed by the at least one processor, causes the at least one processor to perform:
collecting an image of the original model; and
acquiring, by performing joint point identification on the image, the position data of the plurality of skeletal joint points of the original model as the original motion data.

19. The device according to claim 14, wherein the at least one computer program, when executed by the at least one processor, causes the at least one processor to perform:
calculating rotation data of a bone between every two adjacent skeletal joint points based on position data of the every two adjacent skeletal joint points in the plurality of skeletal joint points of the original model in the original motion data; and
acquiring the initial motion data of the virtual character by transplanting rotation data of each bone in the original model to a bone, corresponding to the each bone, of the virtual character as rotation data of the bone of the virtual character.

20. The device according to claim 14, wherein the at least one computer program, when executed by the at least one processor, causes the at least one processor to perform:
calculating an original vector of the plurality of skeletal joint points of the original model using the original motion data, and calculating an initial vector of the plurality of skeletal joint points of the virtual character using the initial motion data;
generating a motion semantic matrix of the target motion based on a skeleton structure of the original model and a predetermined motion semantic adjacency relationship;
acquiring a first product by calculating a product of the motion semantic matrix and the original vector, and acquiring a second product by calculating a product of the motion semantic matrix and the initial vector; and
calculating a distance between the first product and the second product as the target function.

21. The device according to claim 20, wherein the at least one computer program, when executed by the at least one processor, causes the at least one processor to perform:
acquiring a joint point adjacency matrix of the original model, wherein each element value in a row where each skeletal joint point is located in the joint point adjacency matrix represents a joint adjacency relationship of the each skeletal joint point with one of other skeletal joint points;
determining a motion semantic adjacent joint point of each target skeletal joint point of the original model based on a predetermined motion semantic adjacency relationship of the each target skeletal joint point, wherein the predetermined motion semantic adjacency relationship of the each target skeletal joint point comprises a predefined adjacency relationship of the target skeletal joint point with other skeletal joint points; and
acquiring the motion semantic matrix of the target motion by updating an element value of the motion semantic adjacent joint point in a row where the each target skeletal joint point is located in the joint point adjacency matrix.
